(19) United States
(12) Patent Application Publication
(10) Pub. No.: US 2005/0176466 A1
(43) Pub. Date: Aug. 11, 2005

(54) Method and apparatus of verifying and managing multiple systems in a wireless communications device

(76) Inventors: Anthony Verloop, Hsichih City (TW); Alex Yuan, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/776,115

(22) Filed: Feb. 11, 2004

(51) Int. Cl. H04M 1/00

(52) U.S. Cl. 455/558

(57) ABSTRACT

A method of verifying and managing multiple systems in a wireless communications device and the apparatus thereof is disclosed, through which an appropriate wireless communications system can be automatically selected from several other alternative systems to log in a target network system. Also, the selection process of wireless communications system can be carried out according to a user-defined priority basing on a set of external conditions that is related to the network operation costs, so that the network user can attain high efficiency of network usage using the above apparatus.

### BACKGROUND OF THE INVENTION

1. Field of the Invention

The present invention is related to a method and apparatus of verifying and managing multiple systems in a wireless communications device, and more particularly to a method and apparatus of verifying and managing multiple systems for selection of an appropriate wireless communications system among several other alternative systems according to a user-defined priority ordering to log in a target network system.

2. Description of Related Art

The fast developments in the computer, wireless communications and internet-related industries have created a strong demand for 3C products. By integrating the functions of computers, network connectivity and communications under one system, 3C products fit well into the life styles of contemporary people, besides the practical values from using these products.

Recent changes in the personal computer market have confirmed that continuing trend of cross-domain integration of computers, communications and internet technologies. As the prices of notebook computers continue to decrease, many desktop computer users are planning to replace their desktop computers with notebook computers or flat panel computers. Another attention-grabbing item is the personal digital assistant (PDA), because it has the data processing capability and good portability.

Users now not only demand the basic data processing capability in digital devices but also the network connectivity and wireless communications interface. An ordinary network user is able to use a mobile phone, a personal digital assistant (PDA), a notebook computer or flat panel computer equipped with a Bluetooth module to access the Internet domain through open air. A digital computer configured with a Bluetooth module and a repeater can be operated as a base station, through which a bi-directional communication link can be established with one or more mobile stations, such as mobile phones, for voice and data communications.

Currently used wireless communications systems are not yet standardized, and each version is specialized for a somewhat different application. For example, two different systems are respectively developed for point-to-point connection and wireless local area network (WLAN) connection. With such diversity in wireless communications systems, most personal and mobile communications manufacturers adopt one wireless communications system which can bring out the functionality of their products for promotions. However, network users often encounter a compatibility problem across different systems, as the systems installed in the communications devices at respective ends might not be the same. Therefore, future wireless communications devices shall be designed with at least two communications systems.

The majority of network activities are value-added web services that are rendered to the network users for a charge, which might be different for each network user depending on the connection modes used. For example, network users using a GSM system and a net phone (VoIP) get different charge rates. The difference in rates will be directly reflected in the operation costs of network users, so they naturally look for ways to economize on the communications costs by choosing the most efficient wireless communications system and communications channel when several alternatives are equally applicable.

### SUMMARY OF THE INVENTION

The main objective of the present invention is to provide a method of verifying and managing a diverse communications interface of a wireless communications device, whereby an appropriate wireless communications system can be selected from several other alternative systems according to a user-defined priority ordering to log in a target network system, thus enabling the network user to attain high efficiency in the network usage and reduce operation costs.

To this end, the method of the present invention include the acts of:
preparing multiple wireless communications systems in a wireless communications device;
enabling the wireless communications device to use a first network interface to log in a first network system to form a regular line connection after a verification process;
enabling the wireless communications device to use a second network interface to log in a second network system to establish a line connection after a cross verification process;
determining whether the wireless communications device is using the second network system to provide services similar to the first network system; if the wireless communications device is using the second network system in said manner, the system temporarily halts the existing link with the first network system; and
determining whether the above services from the second network system through the second network interface have terminated; if the above services have terminated, the system resumes the original link with the first network system through the first network interface after the verification process.

Using the above method, the wireless communication device, i.e. the digital computer or the repeater, is able to maintain line connection with at least one network system at any given time, in accordance with the user-defined priority ordering. Further, the digital computer or the repeater is capable of switching to another wireless communications system when certain external conditions are changed.

The above first network system represents a GPRS/GSM mobile phone system.

The above second network system is the wireless local area network (WLAN) compliant with the 802.11b protocol.

According to the first aspect of the present invention, using the second network system to provide services similar to the first network system is where a network user can make use of the net phone (VoIP) function on a computer system to make a call to a remote phone through the wireless local area network (WLAN) connection, or the network user can log in the internet to transmit and receive electronic mails through the WLAN.

The second objective of the present invention is to provide a cross verification apparatus to select an appropriate wireless communications system from several other alternative systems in accordance with a user-defined priority ordering, whereby the digital computer using the matching system can be automatically logged in the target network system to form a regular line connection.

To this end, the structure of the present invention comprises:
a microprocessor for data processing, interfacing multiple communications systems and serving as control hub;
a data switch formed by at least two multiplexers and respectively connected to two SIM sockets, wherein one of the two multiplexers controls the path from the first network interface to the two SIM sockets;
a card reader connected through the data switch to the two SIM sockets;
a data link module connected between the microprocessor and the card reader for controlling bi-directional communications; and
a second network interface connected to the microprocessor, and also to the two SIM sockets through the microprocessor and the data switch.

According to the second aspect of the present invention, the above apparatus uses the data switch to select one of the two SIM cards loaded in the respective SIM sockets, so that the system can be linked to the corresponding network system through the first network interface after the verification process. When the system detects that certain external conditions are changed, the first wireless communications system will be replaced by the second wireless communications system, or vice versa. Under the above conditions, the microprocessor orders the data switch to change the data path of the card reader from the first SIM card to the second SIM card, so that data on the second SIM card can be read and passed to the microprocessor, and then the microprocessor initiates a line connection through the second network interface to the second network system.

Other objectives, advantages and novel features of the invention will become more apparent from the following detailed description when taken in conjunction with the accompanying drawings.

### BRIEF DESCRIPTION OF THE DRAWINGS

FIG. 1 is block diagram of the system architecture of the present invention;

FIGS. 2A-H show a circuit diagram of the microprocessor;

FIGS. 3A-3F show a circuit diagram of the data switch/card reader/data link module;

FIGS. 4A-4E show a circuit diagram of the GSM interface; and

FIGS. 5A-5D shown a circuit diagram of a transceiver for WLAN.

### DETAILED DESCRIPTION OF THE PREFERRED EMBODIMENT

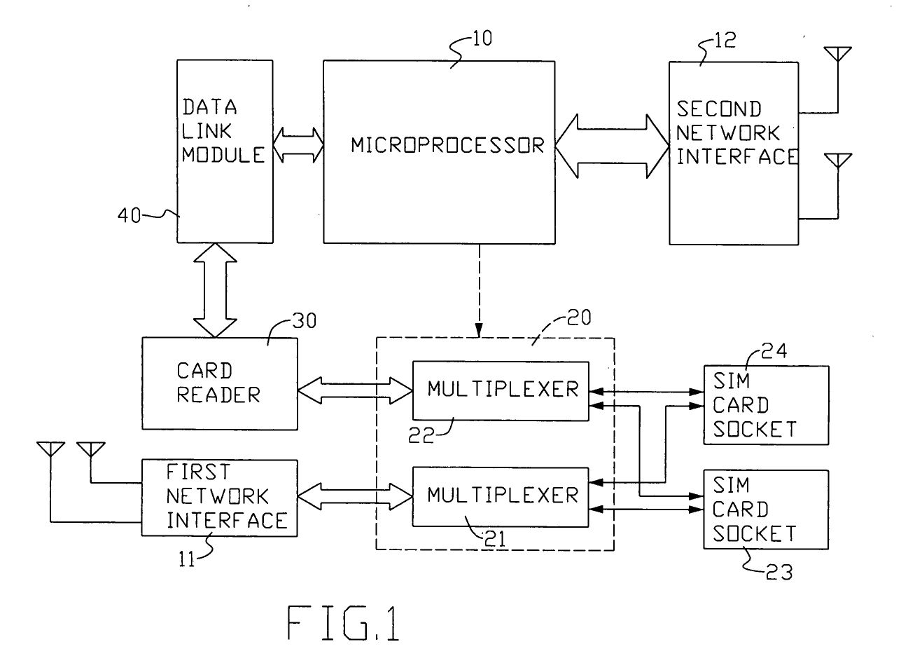

The present invention is illustrated through a preferred embodiment, in which an apparatus of verifying and managing multiple systems in a wireless communications device is provided as shown by FIG. 1.

A microprocessor (10), for data processing, interfacing multiple communications systems and serving as a control hub.

A data switch (20) formed by at least two multiplexers (21) (22), which are respectively connected to two SIM sockets (23) (24) for switching the data paths to the SIM sockets (23) (24) under the control of the microprocessor (10). Each of the two SIM sockets (23) (24) is to receive a SIM card. One of the two multiplexers (21) controls the path from the first network interface (11) to the two SIM sockets (23) (24), whereby the first network interface (11) is able to obtain the read data from the two SIM cards.

A card reader (30) connected to the SIM cards loaded in the two SIM sockets (23) (24) through the action of the data switch (20).

A data link module (40), containing a UART transmitter control circuit, connected between the microprocessor (10) and the card reader (30) for controlling bi-directional communications.

A second network interface (12) connected to the microprocessor (10), through which the second network interface (12) is connected to the data link module (40), card reader (30), and data switch (20), and further connected to the two SIM cards.

Both SIM cards contain the telephone numbers for the GPRS/GSM system; or else one of the two cards carries a GPRS/GSM telephone number, and the other card contains the account number for a wireless local area network (WLAN).

The actual cross-verification is to be explained using the WLAN as an example:

The above first network interface (11) is for making connection to the GPRS/GSM mobile phone system. The second network interface (12) is a wireless transceiver for the WLAN, through which the second network interface (12) can establish a link with the WLAN that supports 802.11b wireless communications protocol.

When the microprocessor (10) orders the multiplexer (21) of the data switch (20) to enable the data path from one of the two SIM cards to the first network interface (11), the first network interface (11) uses the data accessed from the SIM card to log in the GPRS/GSM mobile phone system to form a regular line connection after the cross verification process.

If a personal computing device or a repeater connected to a personal computing device is within the broadcasting range of the WLAN, the microprocessor (10) orders the data switch (20) to connect the card reader (30) and the second SIM card, so that the card reader (30) reads off the data from the second SIM card, and passes them through the data link module (40) to the microprocessor (10). The microprocessor (10) then activates the second network interface (12) which uses the information to initiate a line connection to the WLAN after the cross verification process.

Through the above procedures, a personal computing device (referring to a personal computer, a notebook computer, a flat panel computer or a personal digital assistant (PDA)) or a repeater having the above cross verification apparatus is able to make connection with a mobile phone network and a wireless local area network (WLAN). The mobile phone network provides telephone and data transmission services, and the WLAN provides the local area network connection and web services. It shall be pointed out that the telephone rate for mobile phones is substantially higher than that through the net phone (VoIP) over the Internet.

When a network user uses the net phone (VoIP) to make a telephone call to the remote end, the microprocessor (10) will temporarily terminate the existing link with the mobile phone network. After the call through the net phone (VoIP) has terminated, the microprocessor (10) orders the data switch (20) to switch back to the original line connection through the first network interface (11) to the GPRS/GSM mobile phone system.

By this means, the GSM(Voice)/GPRS(data) service originally provided by the first network system can be transferred to the second network system (WiFi Network) through the application of the net phone (VoIP), such that a higher efficiency of network usage and lower telephone rates can be realized by the network user.

The above mentioned two wireless communications systems can be assigned different priority values according to personal preference of the network user, so that when both systems are equally applicable for linking to a particular target network system, the wireless communications system with the highest priority will be selected automatically. The network interface linking the wireless local area network (WLAN) is often assigned the highest priority for the purposes explained above.

The above two SIM cards may both contain GPRS/GSM telephone numbers. When these two cards both contain the mobile phone numbers, it is still possible to assign a different priority to differentiate the line connections for attaining top efficiency in the network usage.

Using the above method and apparatus, the system is able to maintain line connection with at least one network system at any given time, and through the priority selection the system is capable of selecting a wireless communications system with the highest priority to connect to the target network system.

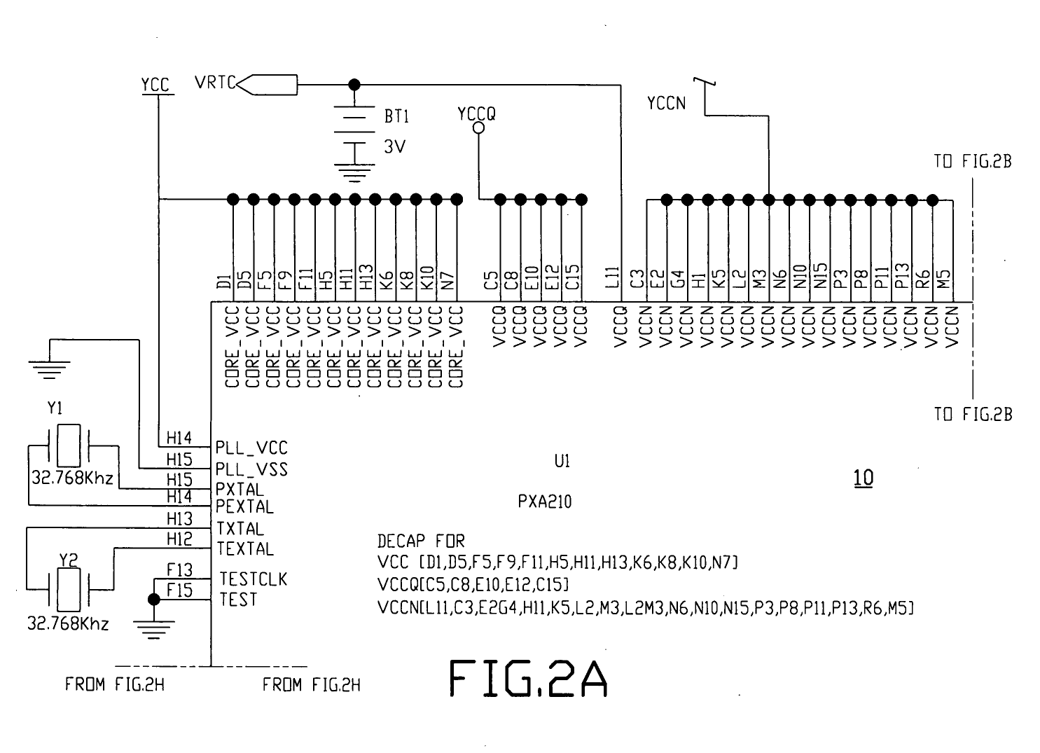

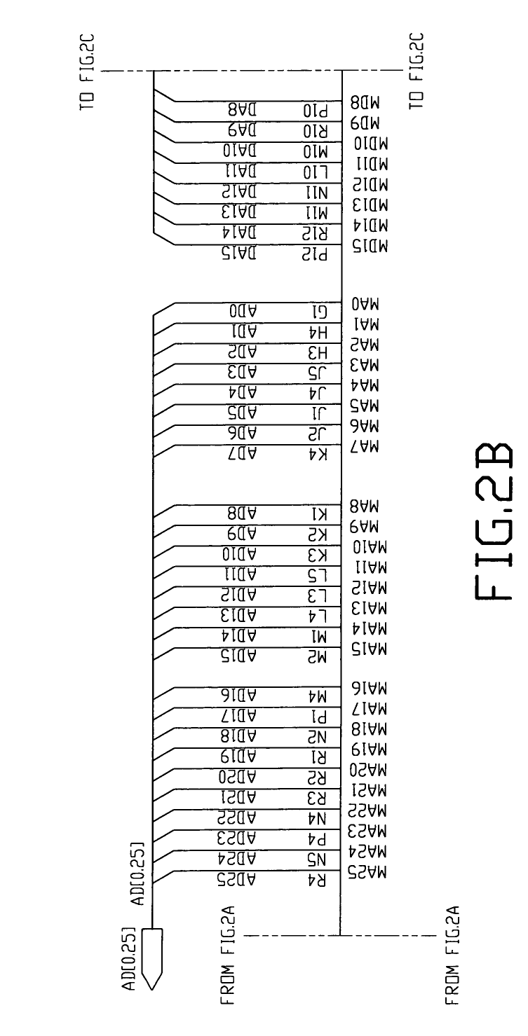

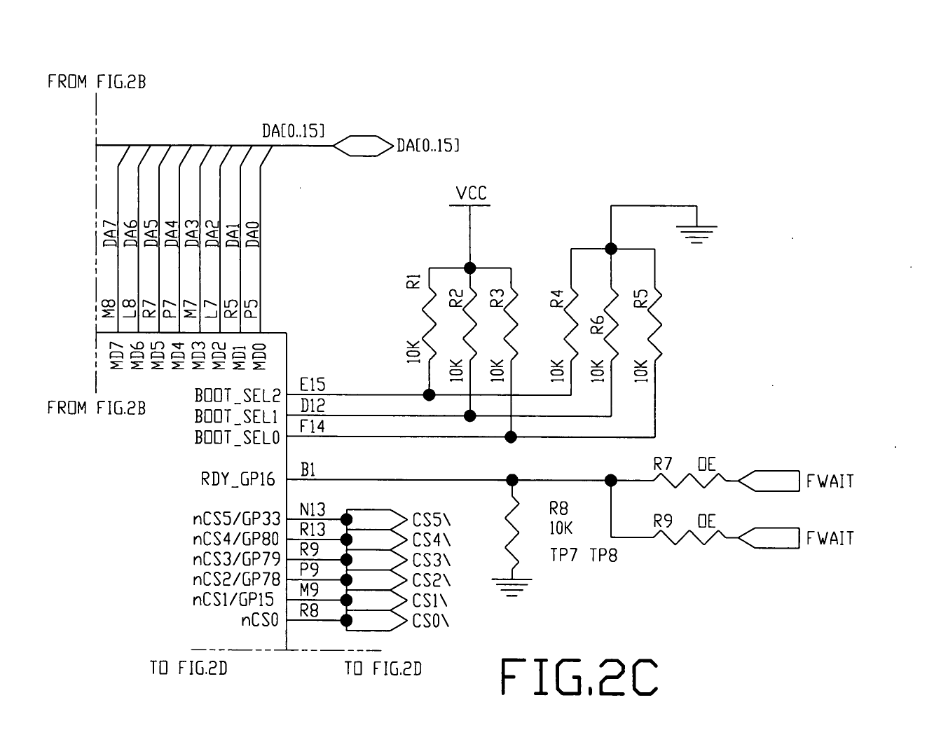

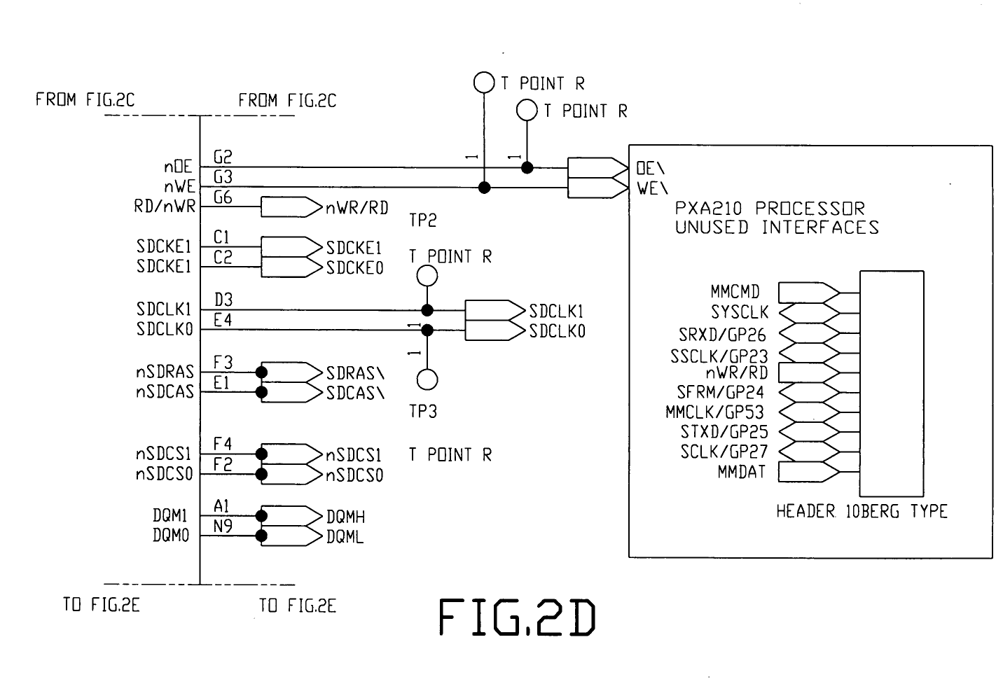

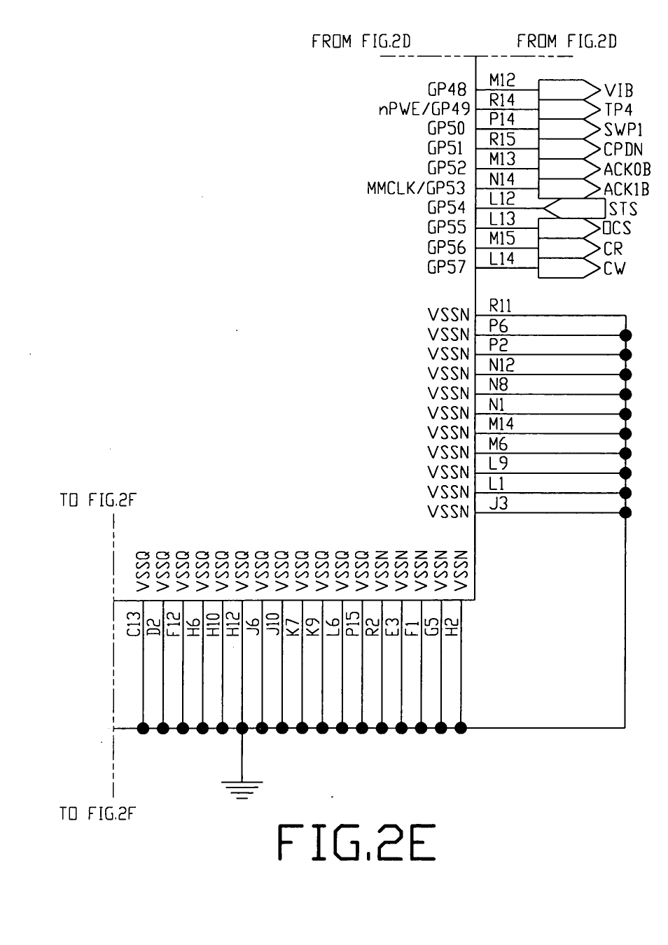

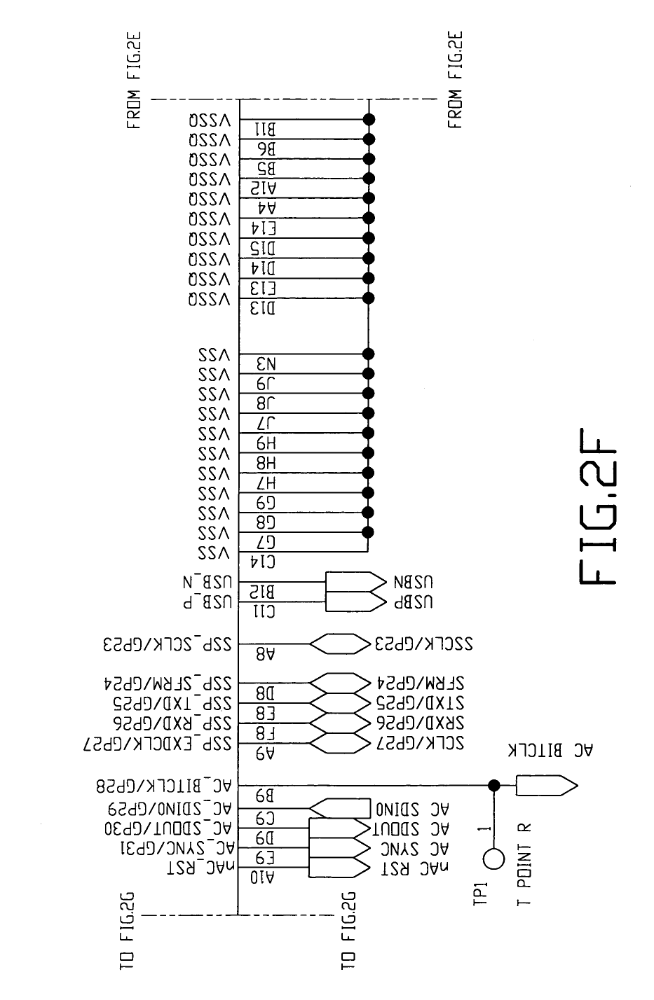

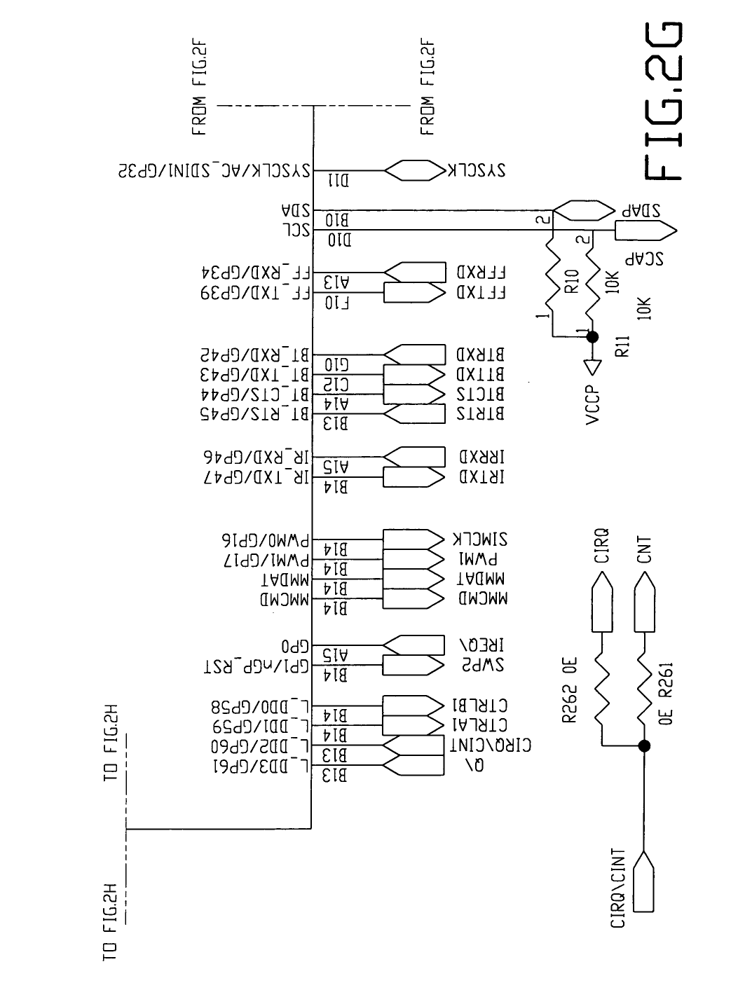

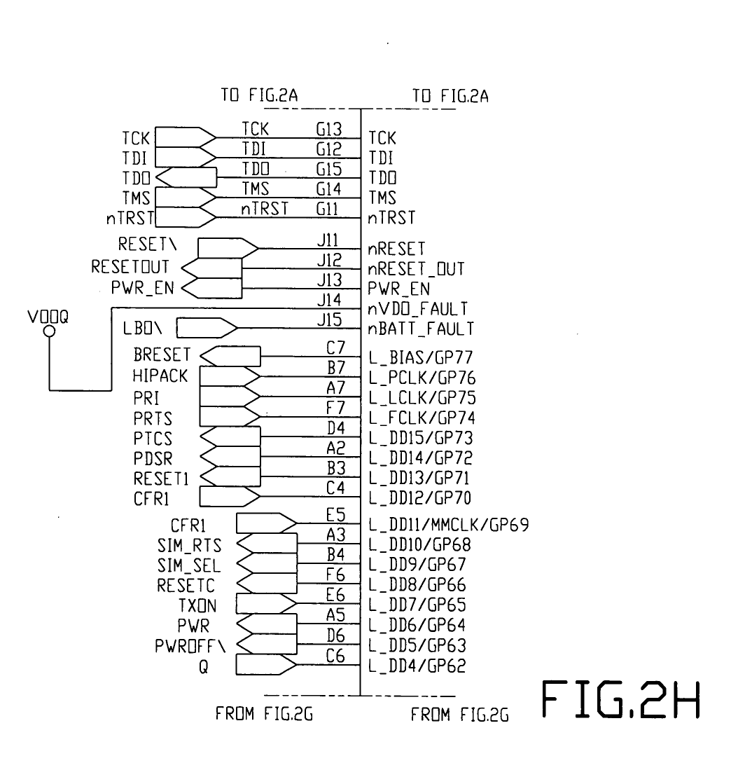

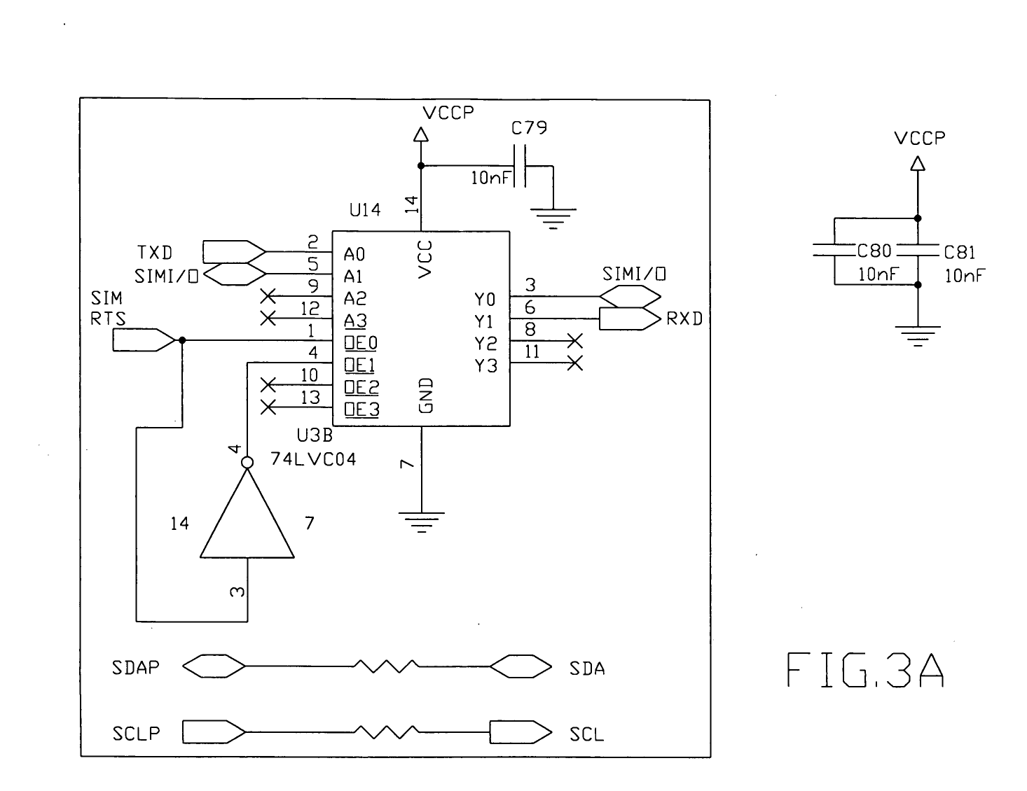

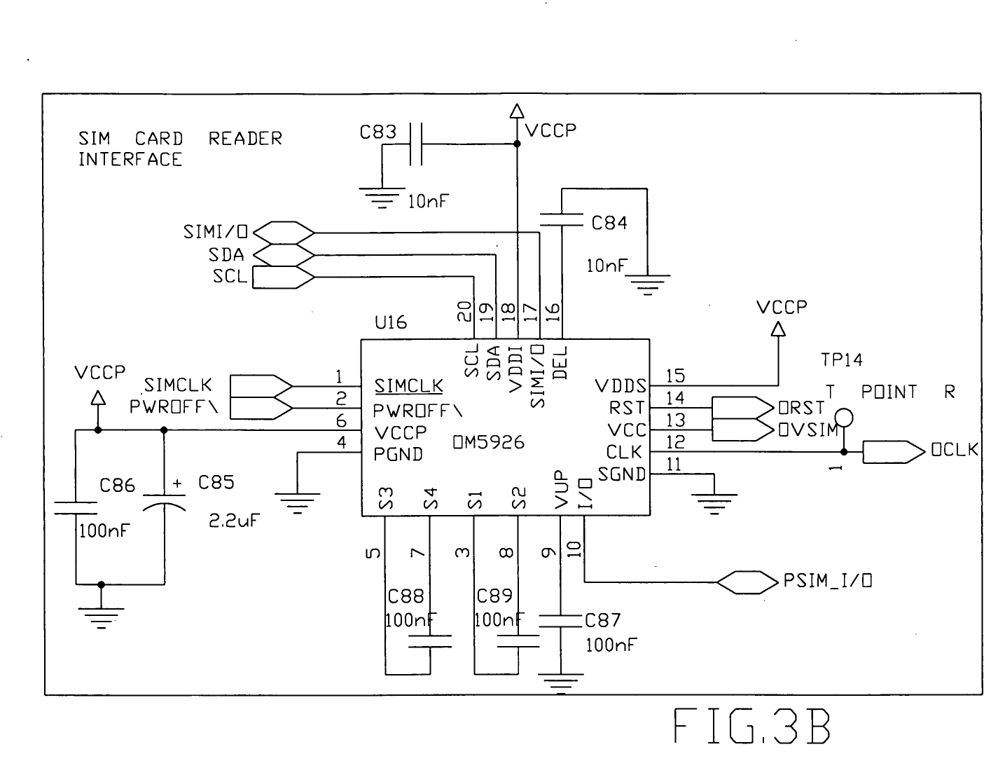

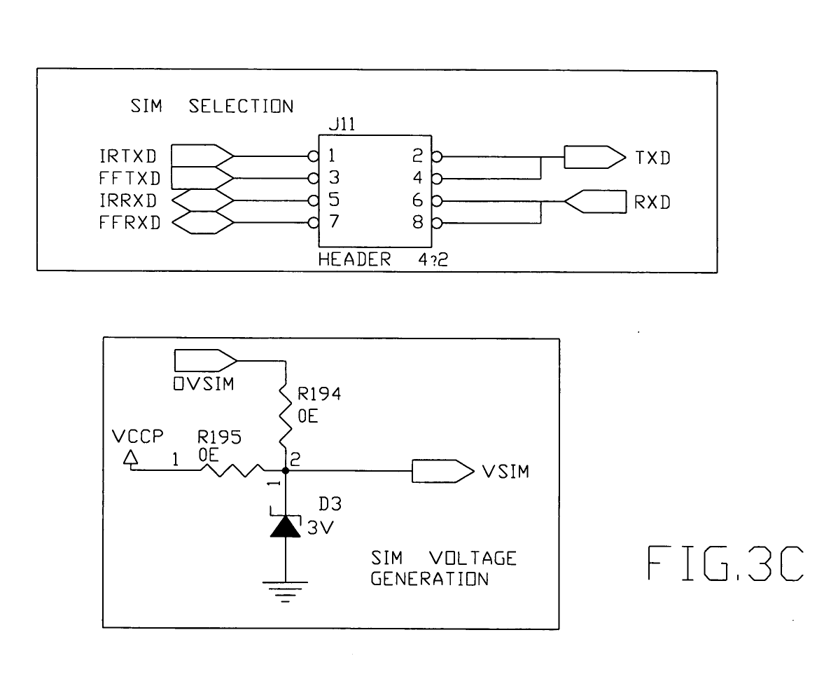

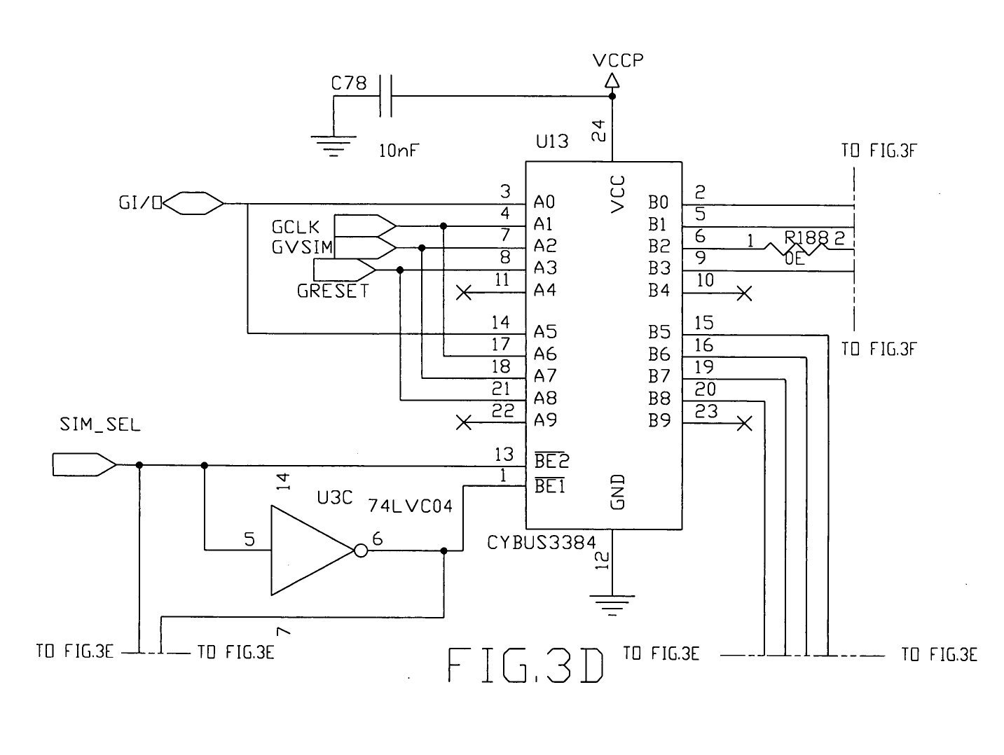

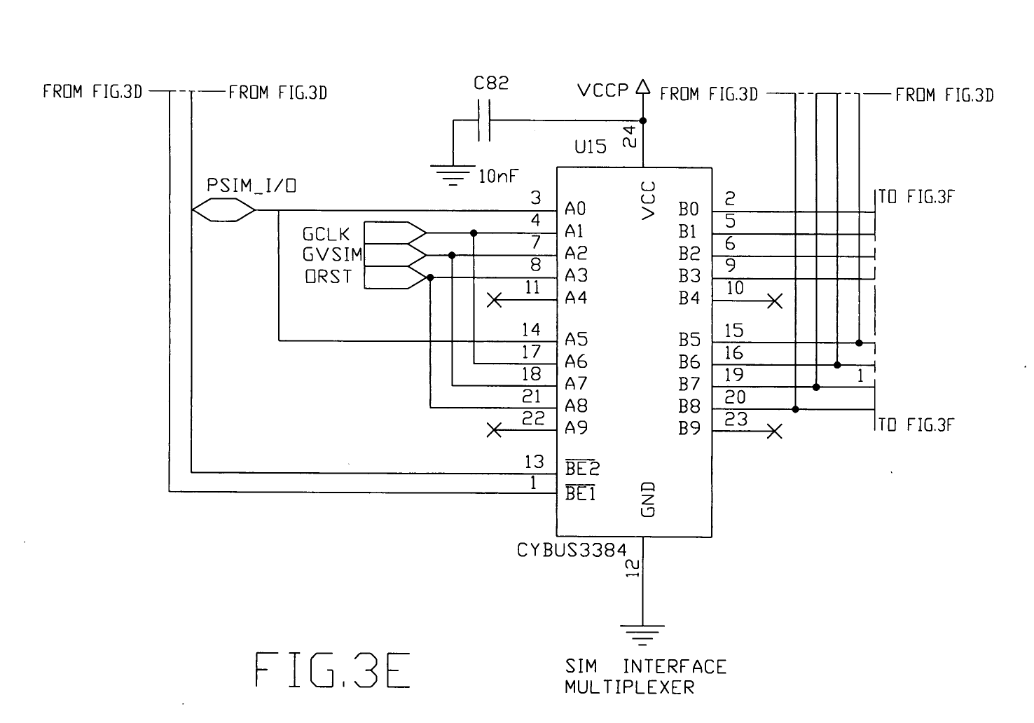

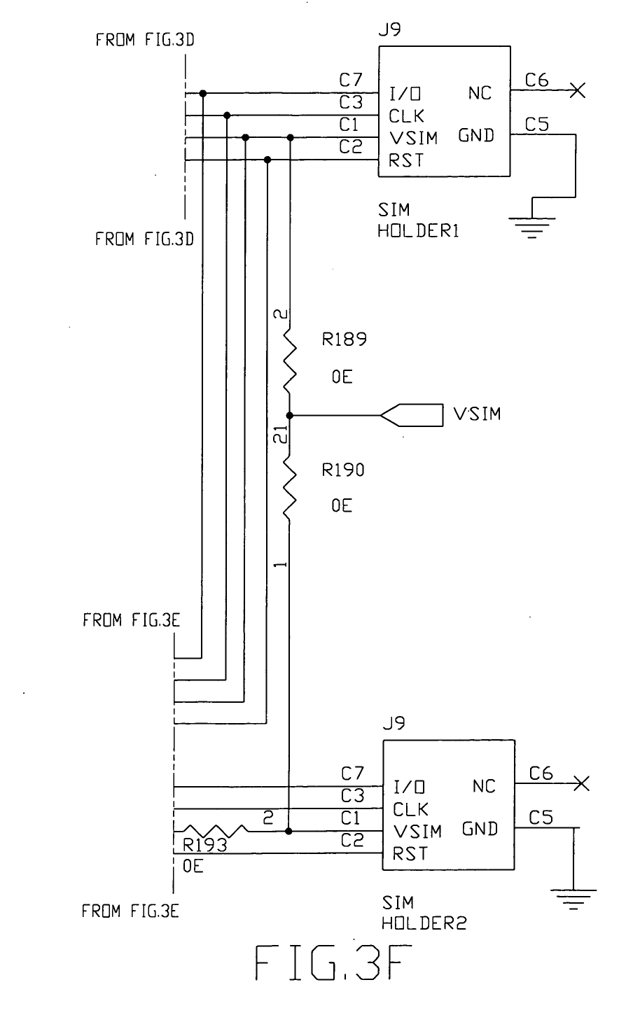

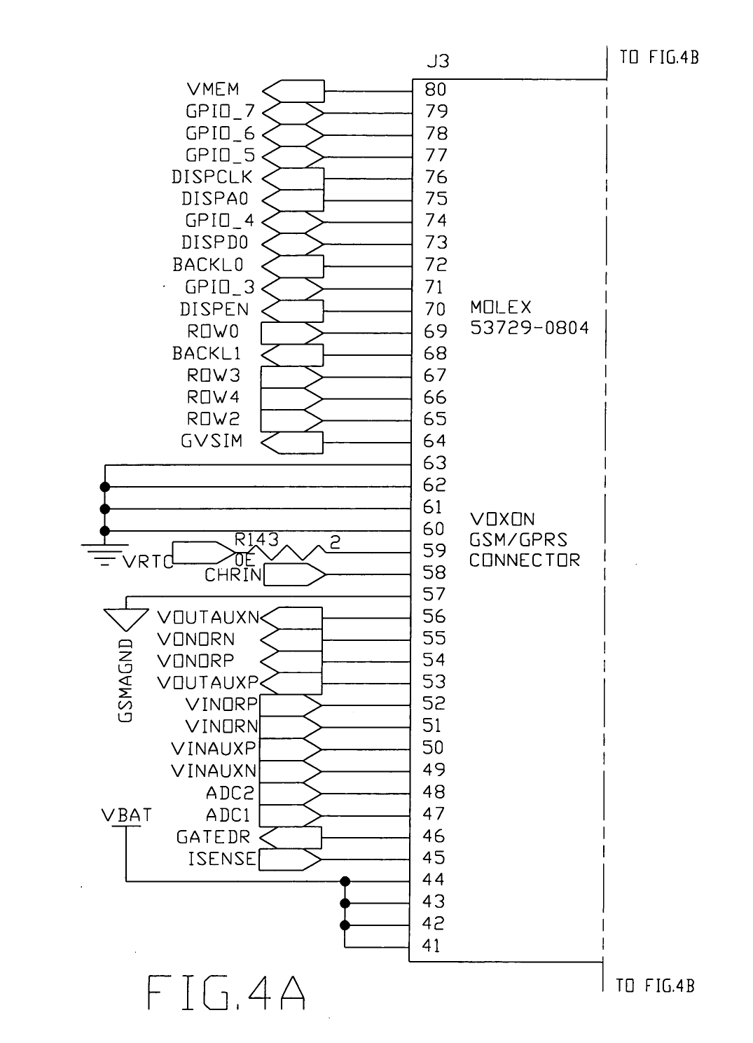

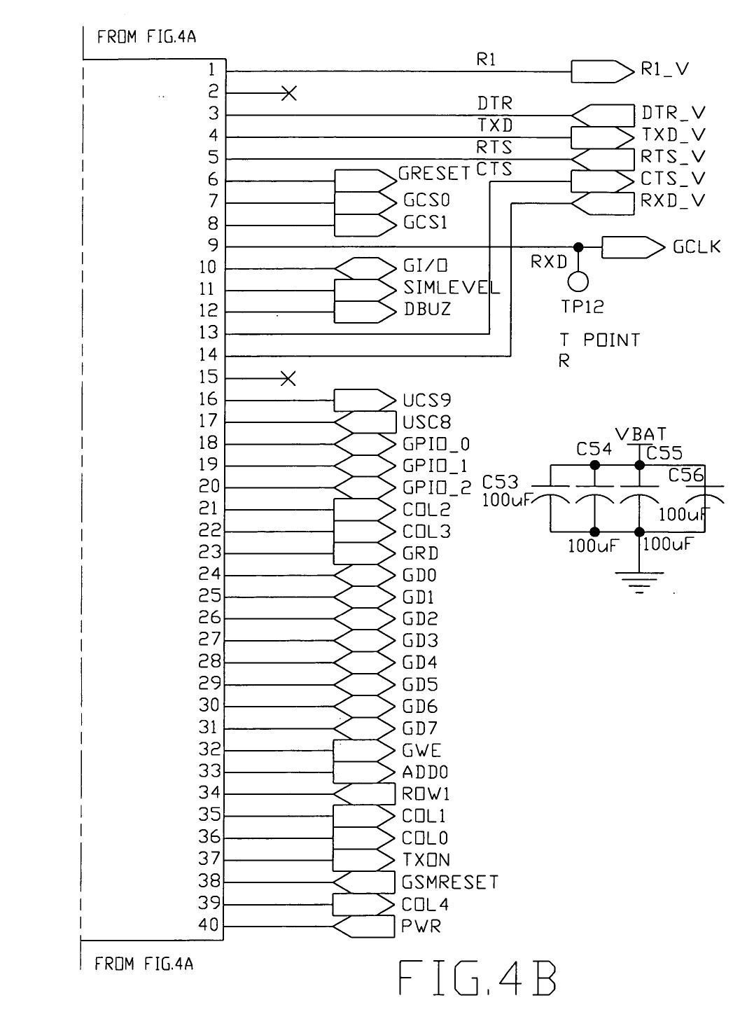

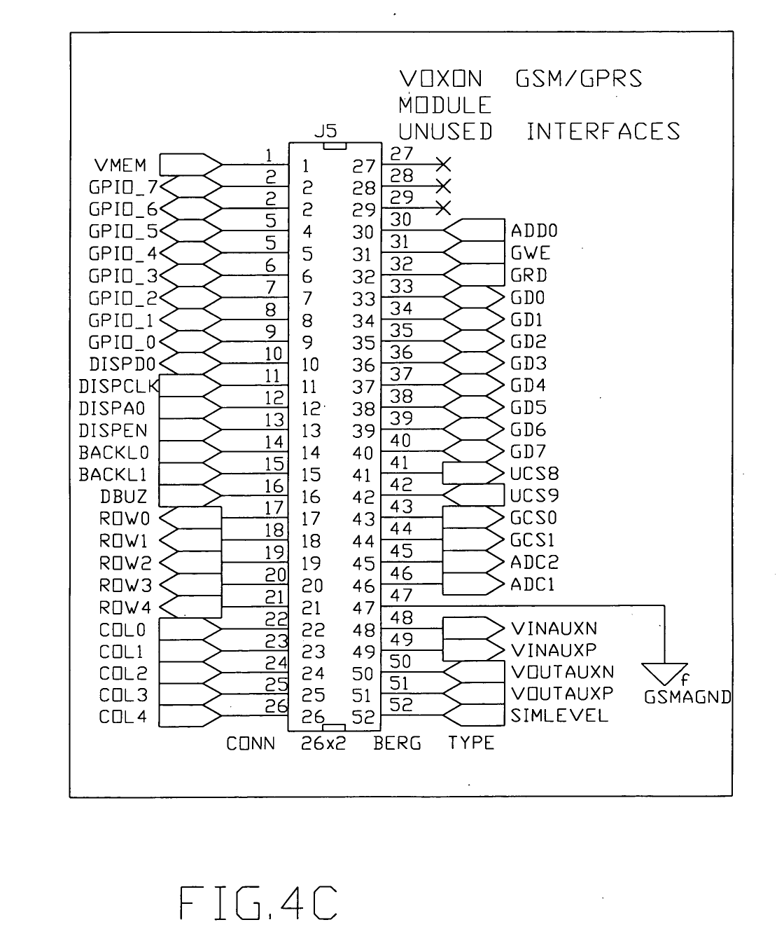

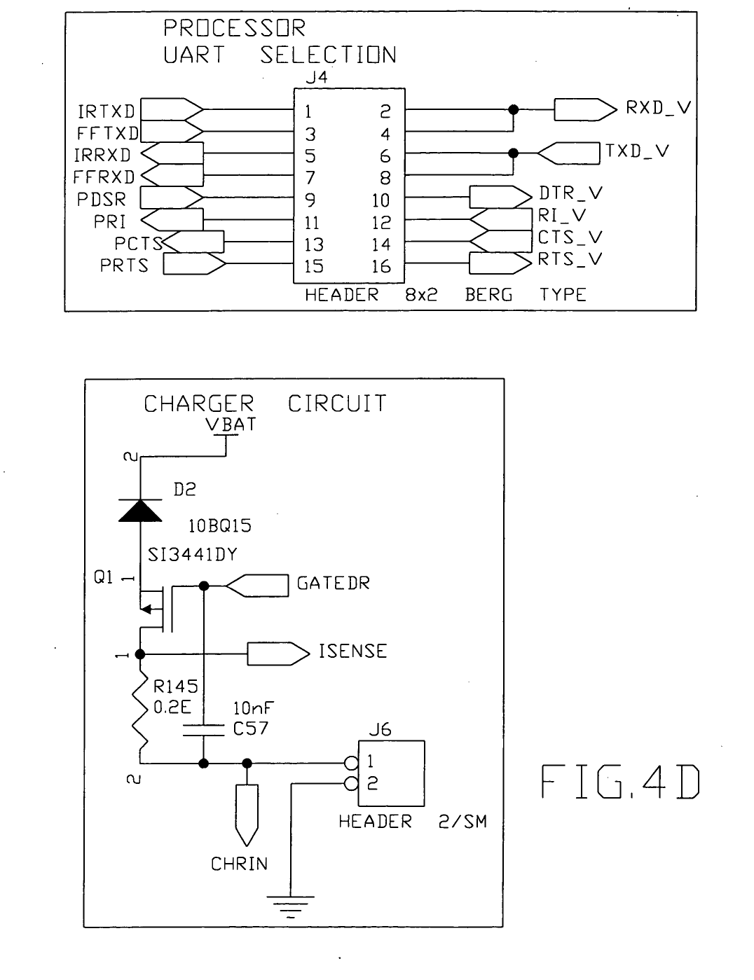

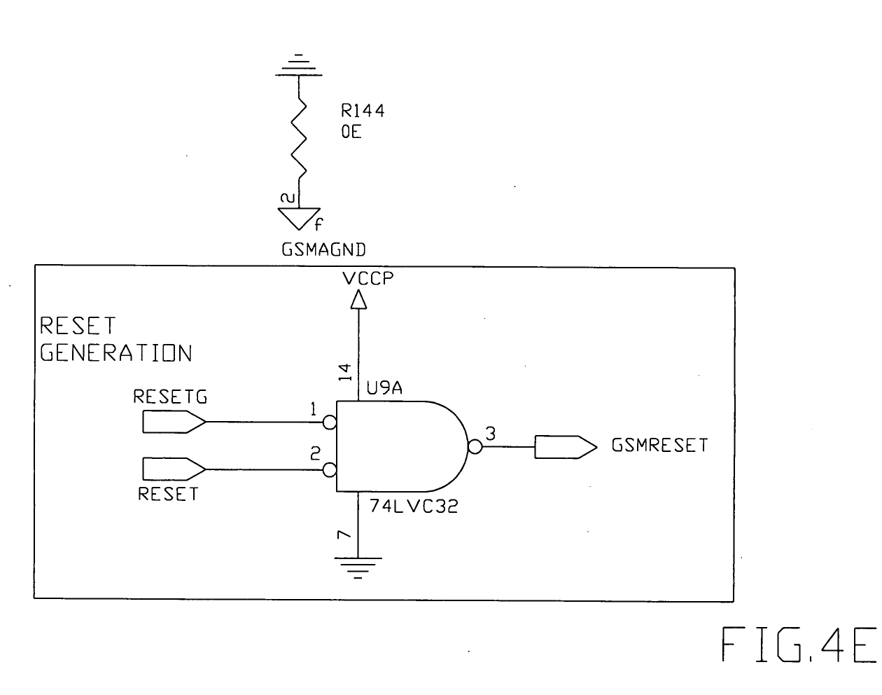

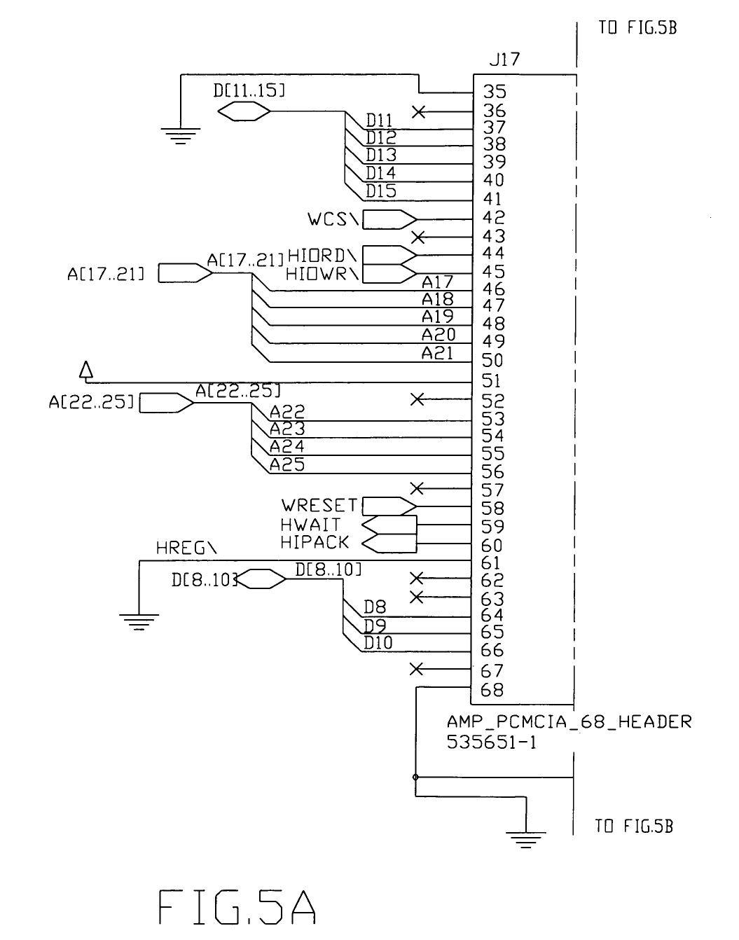

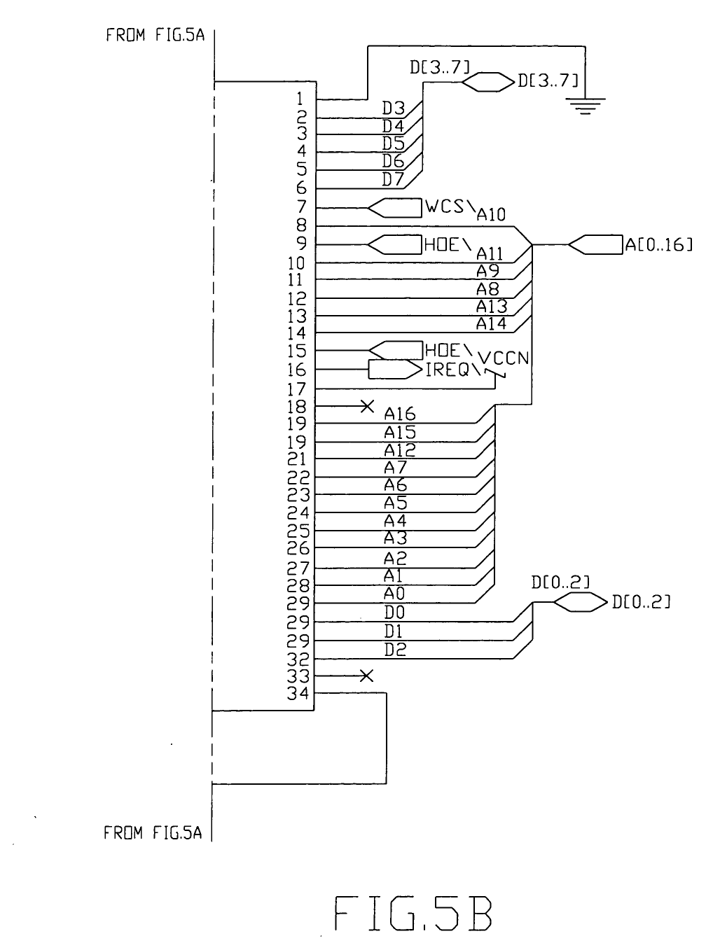

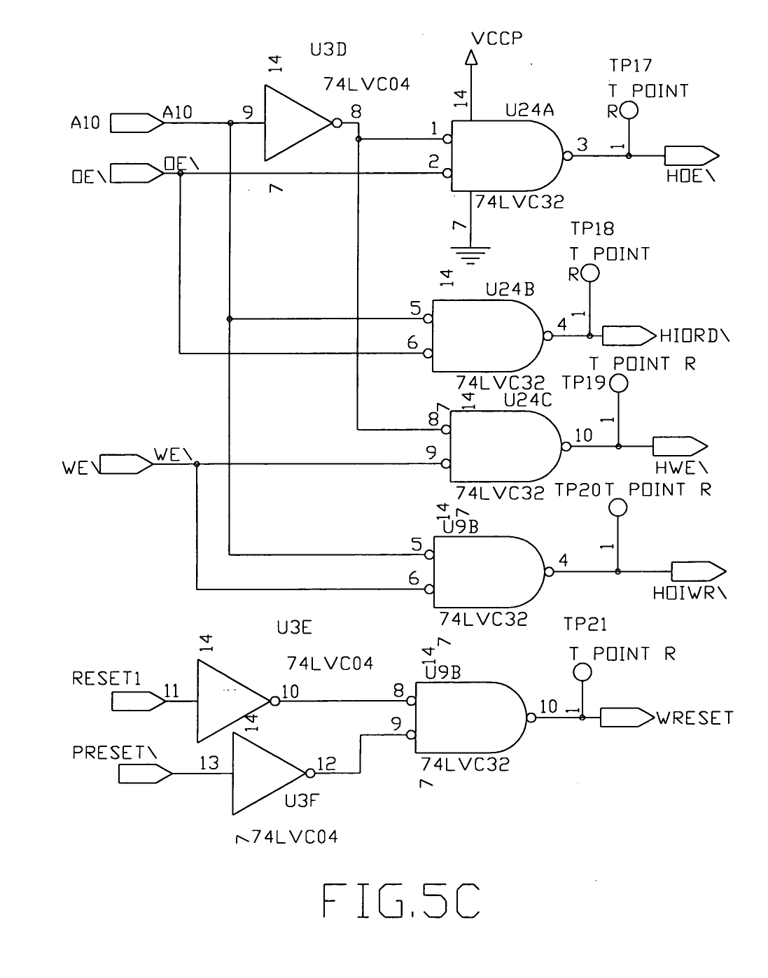

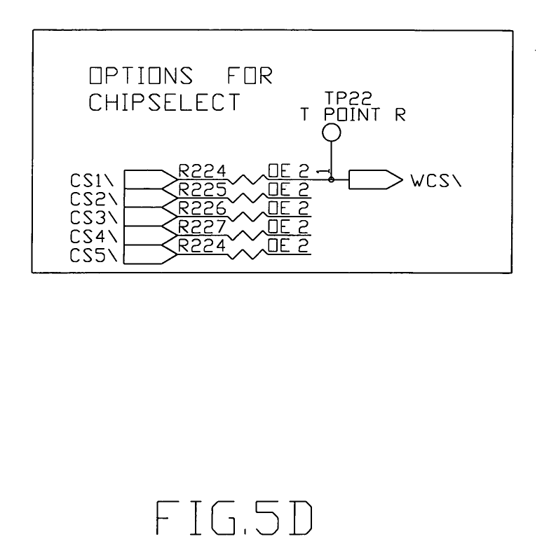

The actual control circuitry for implementing the above cross verification apparatus is illustrated in the circuit diagrams of FIGS. 2A-5D.

The cross verification apparatus of the present invention can be installed in the personal computing device, or set up as a separate peripheral device with line connection to the personal computing device, or the apparatus can be embedded in the repeater, where the repeater is linked to the personal computing device by wireless means, so that the personal computing device is able to select an appropriate wireless communications system from several other alternative systems through the cross verification and priority selection processes.

From the foregoing, the present invention provides a method of cross verification and managing multiple communications systems in a wireless communications device to log in the target network system. In the automatic entry process, a different priority value can be assigned to each alternative communication system, such that an appropriate wireless communications system will be selected automatically, according to a user-defined priority ordering, in the process of establishing a line connection with a target network system, thus top efficiency of network usage can be attained.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A method of verifying and managing multiple systems in a wireless communications device, comprising:
preparing multiple wireless communications systems in the wireless communications device;
enabling the wireless communications device to use a first network interface to log in a first network system to form a regular line connection after a verification process;
enabling the wireless communications device to use a second network interface to log in a second network system to establish a line connection after a cross verification process;
determining whether the wireless communications device is using the second network system to provide services similar to the first network system; if the wireless communications device is using the second network system in said manner, the system temporarily halts the existing link with the first network system; and
determining whether the above services from the second network system through the second network interface have terminated; if the above services have terminated, the system resumes the original link with the first network system through the first network interface after the verification process.

2. The method as claimed in claim 1, wherein the first network system is a mobile phone network.

3. The method as claimed in claim 2, wherein the mobile phone network is GPRS.

4. The method as claimed in claim 2, wherein the mobile phone network is GSM.

4. The method as claimed in claim 1, wherein the second network system is a wireless local area network (WLAN).

5. The method as claimed in claim 3, wherein the second network system is a wireless local area network (WLAN).

6. The method as claimed in claim 4, wherein the second network system is a wireless local area network (WLAN).

7. The method as claimed in claim 4, wherein using the second network system to provide services similar to the first network system is where a network user uses a net phone (VoIP) through the wireless local area network (WLAN) to make a telephone call to a remote user.

8. The method as claimed in claim 5, wherein using the second network system to provide services similar to the first network system is where a network user uses a net phone (VoIP) through the wireless local area network (WLAN) to make a telephone call to a remote user.

9. The method as claimed in claim 6, wherein using the second network system to provide services similar to the first network system is where a network user uses a net phone (VoIP) through the wireless local area network (WLAN) to make a telephone call to a remote user.

10. The method of cross verification according to claim 1, wherein the wireless communications device is a personal computing device coupled with a transceiver or Bluetooth module.

11. The method of cross verification according to claim 1, wherein the wireless communications device is a wireless repeater connected to a personal computing device.

12. The method as claimed in claim 10, wherein the personal computing device is a personal computer, a notebook computer, a flat panel computer or a personal digital assistant (PDA).

13. A cross verification apparatus for cross-verification of wireless communications system, the apparatus comprising:
a microprocessor (10), for data processing, interfacing of wireless communications system and serving as a control hub;
a data switch (20) formed by at least two multiplexers (21) (22), which are respectively connected to two SIM sockets (23) (24), wherein one of the two multiplexers (21) (22) controls a path from a first network interface (11) to two SIM cards loaded in the two SIM sockets (23) (24);
a card reader (30), which connects to the two SIM cards in the two SIM sockets (23) (24) through the data switch (20);
a data link module (40) connected in between the microprocessor (10) and the card reader (30) for controlling bi-directional data communications; and
a second network interface (12) connected to the microprocessor (10), through which the second network interface (12) is connected to the data link module (40), card reader (30), and data switch (20), and further connected to the two SIM cards loaded in the two SIM socket (23) (24);
whereby the first network interface (11) is able to be switched to one of the SIM cards through the data switch (20) to log in the respective network system and establish a line connection after the cross-verification process;
the card reader (30) is able to access data from one of the SIM cards through the data switch (20), and then pass the data to the microprocessor (10) to initiate a connection through the second network interface (12) to the second network system.

14. The cross verification apparatus as claimed in claim 13, wherein the first network interface (11) is based on the GPRS/GSM system.

15. The cross verification apparatus as claimed in claim 13, wherein the second network interface (12) is a transceiver for a WLAN.

16. The cross verification apparatus as claimed in claim 13, wherein the cross verification apparatus is installed in a wireless communications device.

17. The cross verification apparatus as claimed in claim 16, wherein the wireless communication device is a personal computer, a notebook computer, a flat panel computer or a personal digital assistant (PDA).

18. The cross verification apparatus as claimed in claim 13, wherein the cross verification apparatus is set up as a separate peripheral device with line connection to the personal computing device.

19. The cross verification apparatus as claimed in claim 13, wherein the cross verification apparatus is embedded in a repeater.
